(19) United States
(12) Patent Application Publication
(10) Pub. No.: US 2023/0022380 A1
(43) Pub. Date: Jan. 26, 2023

(54) ELECTRONIC DEVICE AND METHOD FOR IMAGE STABILIZATION BY CONSIDERING ANTENNA PERFORMANCE

(71) Applicant: Samsung Electronics Co., Ltd., Suwon-si (KR)

(72) Inventor: Changrim YU, Suwon-si (KR)

(21) Appl. No.: 17/860,831

(22) Filed: Jul. 8, 2022

Related U.S. Application Data
(63) Continuation of application No. PCT/KR2022/009771, filed on Jul. 6, 2022.

(30) Foreign Application Priority Data
Jul. 16, 2021 (KR) 10-2021-0093333

(51) Int. Cl. H04N 5/232; H04M 1/72454

(52) U.S. Cl. CPC H04N 5/23258; H04N 5/23245; H04N 5/232935; H04N 5/23287; H04M 1/72454; H04M 2250/52

(57) ABSTRACT

An electronic device is provided. The electronic device includes a camera, an antenna, and a processor operatively connected to the camera and the antenna. The processor may obtain an image of an object by controlling the camera, may obtain signal quality received by the antenna, and may select and perform, based on the signal quality, at least one of a first correction for moving a lens of the camera based on a vibration direction of the electronic device and a second correction for generating a corrected image based on at least some area of the image of the object.

### CROSS-REFERENCE TO RELATED APPLICATION(S)

This application is a continuation application, claiming priority under § 365(c), of an International application No. PCT/KR2022/009771, filed on Jul. 6, 2022, which is based on and claims the benefit of a Korean patent application number 10-2021-0093333, filed on Jul. 16, 2021, in the Korean Intellectual Property Office, the disclosure of which is incorporated by reference herein in its entirety.

### TECHNICAL FIELD

The disclosure relates to an electronic device. More particularly, the disclosure relates to a technology about a method of performing, by an electronic device, image stabilization when a camera is used based on radiation performance of an antenna, for example.

### BACKGROUND ART

With the development of the mobile communication technology and hardware/software technology, a portable electronic device (hereinafter referred to as an “electronic device”) has been able to implement functions using various applications and hardware members in addition to a conventional call function. For example, the electronic device may have at least one camera module mounted on one side a housing, and may recognize at least one object located ahead of and behind thereof by using the camera module.

According to various embodiments, when a camera of the electronic device operates, an object image may be distorted due to the shaking of a user's hand. The electronic device may include at least one means capable of correcting the distortion of an image attributable to the shaking of the hand.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

A conventional electronic device performs image stabilization by using a method of performing image stabilization by a physical movement of a lens included in a camera module or a method of cutting some area of an obtained object image or combining several sheets of images. When such a correction is performed, radiation performance of an antenna located close to the camera module may be affected. A conventional electronic device may select a correction method without considering an operation of the camera affecting radiation performance of the antenna. That is, image stabilization is chiefly processed according to a determined method regardless of a change in signal quality of the antenna. Accordingly, performance of the antenna may deteriorate.

Aspects of the disclosure are to address at least the above-mentioned problems and/or disadvantages and to provide at least the advantages described below. Accordingly, an aspect of the disclosure is to provide a method of selecting a correction method, which can minimize the influence of an operation of a camera on radiation performance of an antenna, when an electronic device performs image stabilization upon photographing using the camera as described above.

Additional aspects will be set forth in part in the description which follows and, in part, will be apparent from the description, or may be learned by practice of the presented embodiments.

### Solution to Problem

In accordance with an aspect of the disclosure, an electronic device is provided. The electronic includes a camera, an antenna, and a processor operatively connected to the camera and the antenna. The processor may obtain an image of an object by controlling the camera, may obtain signal quality received by the antenna, and may select and perform, based on the signal quality, at least one of a first correction for moving a lens of the camera based on a vibration direction of the electronic device and a second correction for generating a corrected image based on at least some area of the image of the object.

In accordance with another aspect of the disclosure, a method of performing, by an electronic device, image stabilization in which antenna performance is taken into consideration is provided. The method includes obtaining an image of an object by controlling a camera, obtaining signal quality received by the antenna, and selecting and performing, based on the signal quality, at least one of a first correction for moving a lens of the camera based on a vibration direction of the electronic device and a second correction for generating a corrected image based on at least some area of the image of the object.

### Advantageous Effects of Invention

According to various embodiments, the electronic device can select a method of performing image stabilization based on signal quality of an antenna. The electronic device can perform image stabilization when a camera is used while minimizing performance deterioration of an antenna. Furthermore, the electronic device can identify a correction method selection criterion based on various photographing modes provided by the camera, and can select an optimum correction method in which antenna performance is considered in each photographing mode.

In addition, an effect which may be obtained or predicted according to various embodiments of the present electronic device is directly or implicitly disclosed in the detailed descriptions of embodiments of the electronic device. For example, various effects predicted according to various embodiments of the electronic device will be disclosed in the detailed description to be described.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the description will be more apparent from the following description taken in conjunction with the accompanying drawings, in which:

FIG. 1 is a block diagram of an electronic device within a network environment according to an embodiment of the disclosure;

FIG. 2 is a rear view of an electronic device according to an embodiment of the disclosure;

FIG. 3 is a block diagram of an electronic device according to an embodiment of the disclosure;

FIG. 4 illustrates an embodiment in which a graphic user interface (UI) is displayed in a camera application of an electronic device according to an embodiment of the disclosure;

FIG. 5 illustrates an operating principle of a first correction of an electronic device according to an embodiment of the disclosure; and

FIG. 6 is a flowchart of a method of performing, by an electronic device, image stabilization device according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments, a description of contents that are well known in the art to which the disclosure pertains and not directly related to the disclosure is omitted. Furthermore, in the drawings, a detailed description of elements having substantially the same construction and function is omitted.

For the same reason, in the accompanying drawings, some elements are enlarged, omitted, or depicted schematically. Furthermore, the size of each element does not accurately reflect its real size. Accordingly, the disclosure is not restricted by the relative sizes or spaces that are drawn in the figures.

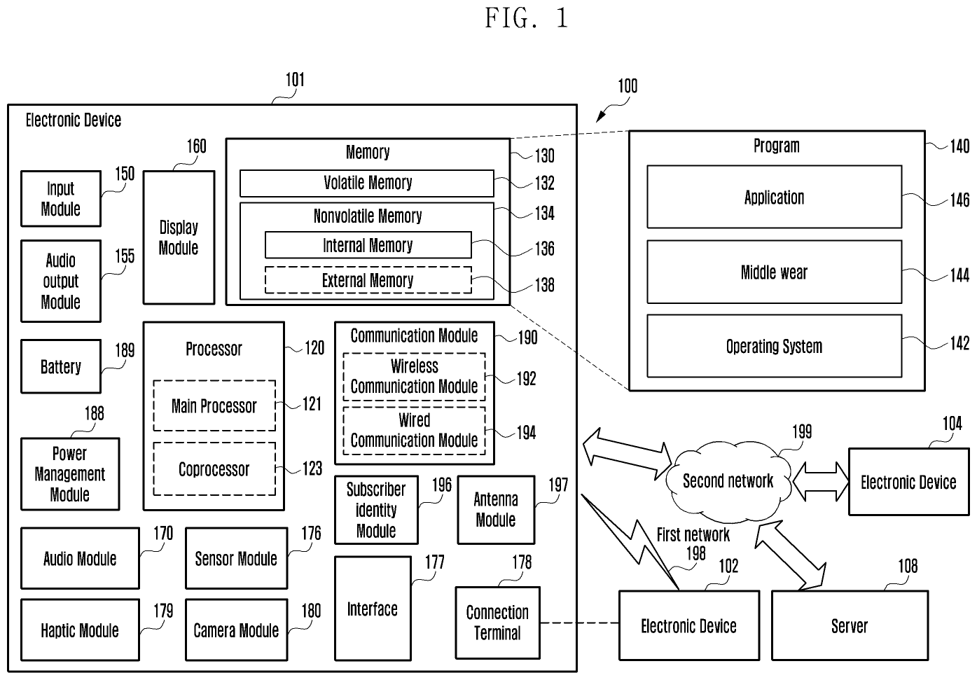

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

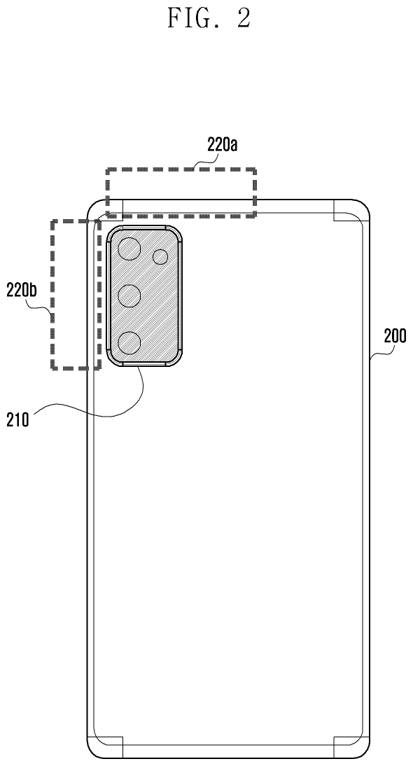

FIG. 2 is a rear view of an electronic device according to an embodiment of the disclosure.

Referring to FIG. 2, an electronic device 200 may include a camera 210 and at least one antenna 220 (e.g., antennas 200a and 200b in FIG. 2). The camera 210 may be mounted on at least one of front and rear surfaces of the electronic device 200. The antenna 220 may be mounted on at least one side of a side housing. The camera 210 may protrude from one area of the housing, and may be mounted thereon. The camera may include at least one lens. The electronic device 200 may recognize an object located on the front or rear surface of the electronic device 200 by executing a camera application. The electronic device 200 may recognize an object by combining images obtained from at least one lens. Locations of the electronic device 200 where the camera 210 and the antenna 220 are mounted are not limited to the locations illustrated in the drawing.

According to various embodiments, the electronic device 200 may establish a communication connection with an external device or an external antenna by using the antenna 220. The electronic device 200 may include at least one antenna 220 for transmitting and receiving information to and from the external device. For example, the electronic device 200 may include a first antenna 200a disposed on the upper side thereof and a second antenna 200b disposed on the side of the housing, as illustrated in FIG. 2.

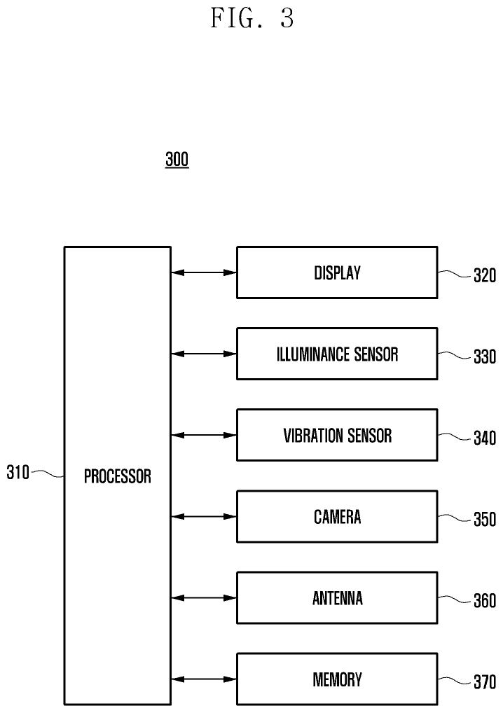

FIG. 3 is a block diagram of an electronic device according to an embodiment of the disclosure.

Referring to FIG. 3, an electronic device 300 may include a display 320, an illuminance sensor 330, a vibration sensor 340, a camera 350, an antenna 360, a processor 310, and a memory 370. In various embodiments, some of the illustrated elements may be omitted or substituted with other elements. The electronic device 300 may further include at least some of the elements and/or functions of the electronic device 101 in FIG. 1. At least some of the illustrated (or not-illustrated) elements of the electronic device 300 may be mutually operatively, functionally and/or electrically connected.

According to various embodiments, the display 320 may display various images under the control of the processor 310. The display 320 may be implemented as any one of a liquid crystal display (LCD), a light-emitting diode (LED) display, a micro LED display, a quantum dot (QD) display, or an organic light-emitting diode (OLED) display, but the disclosure is not limited thereto. The display 320 may be formed as a touch screen in which a touch and/or a proximity touch (or hovering) input using a part (e.g., a finger) of the body of a user or an input device (e.g., a stylus pen) is detected. The display 320 may include at least some of the elements and/or functions of the display module 160 in FIG. 1.

According to various embodiments, at least a part of the display 320 may be flexible, and the display 320 may be implemented as a foldable display or a rollable display.

According to various embodiments, the illuminance sensor 330 may include at least some of the elements and/or functions of the sensor module 176 in FIG. 1, and may measure illuminance around the electronic device 300. The illuminance sensor 330 may be implemented as any one of a photo sensor, a cadmium sulfide (CDS) sensor, an ultra violet (UV) sensor, and an ambient illuminance sensor (ALS), and the disclosure is not limited thereto.

According to various embodiments, the vibration sensor 340 may measure a vibration angle of the electronic device 300 by measuring at least one of displacement, a speed, and acceleration. The vibration sensor 340 may include at least one of a displacement sensor, a speed sensor, and an acceleration sensor. The displacement sensor may measure a change in the distance between a rotating element and housing of the electronic device 300. The speed sensor and the acceleration sensor may measure the speed and acceleration of an element to which the sensor is attached. The vibration sensor 340 may measure a vibration angle of the electronic device 300 based on information obtained by a displacement sensor, a speed sensor, and an acceleration sensor.

According to various embodiments, the camera 350 may obtain external image data. The camera 350 may obtain image data by using image sensors using various methods, such as a charge coupled device (CCD) and a complementary metal oxide semiconductor (CMOS). The camera 350 may include at least some of the elements and/or functions of the camera module 180 in FIG. 1. One or more cameras 350 may be disposed on the front surface and/or rear surface of the housing of the electronic device 300. Hereinafter, image data including an external device may be obtained using the camera 350 on the rear surface of the housing unless described otherwise.

According to various embodiments, the antenna 360 may include a near field communication (NFC) antenna, a wireless charging antenna and/or a magnetic secure transmission (MST) antenna, for example. The antenna 360 may perform short-distance communication with an external device or may wirelessly transmit and receive power necessary for charging, for example.

According to various embodiments, the memory 370 may include a volatile memory (e.g., the volatile memory 132 in FIG. 1) and a nonvolatile memory (e.g., the non-volatile memory 134 in FIG. 1), and may temporarily or permanently store various data. The memory 370 may include at least some of the elements and/or functions of the memory 130 in FIG. 1, and may store the program 140 in FIG. 1.

According to various embodiments, the memory 370 may store various instructions which may be executed in the processor 310. Such instructions may include control commands for arithmetic and logical operations, a data transfer, and an input and output, which may be recognized by the processor 310.

According to various embodiments, the processor 310 may be an element that is operatively, functionally and/or electrically connected to elements (e.g., the display 320, the illuminance sensor 330, the vibration sensor 340, the camera 350, the antenna 360, and the memory 370) of the electronic device 300 and that is capable of performing an operation or data processing about control and/or communication of each of the elements. The processor 310 may include at least some of the elements and/or functions of the processor 120 in FIG. 1.

According to various embodiments, an operation and a data processing function which may be implemented in the electronic device 300 by the processor 310 are not limited, but various embodiments for selecting a method of performing image stabilization, which minimizes the deterioration of antenna performance, are described below. Operations of the processor 310 to be described later may be performed by loading instructions stored in the memory 370.

According to various embodiments, the processor 310 may execute a camera application and identify a photographing mode. The camera 350 may perform photographing in at least one photographing mode that provides various functions. For example, the processor 310 may select at least one photographing mode among a photo photographing mode, a video photographing mode, and a video call mode. According to an embodiment, in the case of the video call mode, the processor 310 may activate a front camera by controlling the camera 350. The processor 310 may display, on the display 320, a graphic user interface (UI) indicative of the switching of the camera 350, and may change the front camera and a rear camera based on a user input to the graphic UI.

According to various embodiments, the processor 310 may perform image stabilization by using various methods. For example, the processor 310 may perform image stabilization by using a first correction (e.g., optical image stabilization (OIS) or tilt optical image stabilization (tOIS)) for performing image stabilization by using a physical movement of a lens of the camera 350 and a second correction (e.g., video digital image stabilization (VDIS), an electric image stabilizer (EIS), or a digital image stabilizer (DIS)) for generating a corrected image by cropping at least one area of an image of an object. Hereinafter, it is described that the first correction and the second correction are included in the method of performing image stabilization, which is provided by the processor 310, but an embodiment of the disclosure is not limited thereto.

According to various embodiments, the processor 310 may select a proper method among various methods of performing image stabilization based on at least one criterion. Hereinafter, various criteria for selecting, by the processor 310, a correction method are described in detail.

According to various embodiments, the processor 310 may select a correction method based on signal quality of the antenna 360. As described with reference to FIG. 2, as the camera 350 and the antenna 360 may be disposed close to each other, an operation of the camera 350 may deliver an interference signal to the antenna 360 and affect signal quality of the antenna 360. The processor 310 may measure received signal quality of the antenna 360, and may perform image stabilization based on the measured signal quality. The signal quality may be identified as a received signal strength indicator (RSSI), reference signal received power (RSRP), reference signal received quality (RSRQ), a signal to noise ratio (SNR), or a signal to interference-plus-noise ratio (SINR). The processor 310 may identify reference signal quality, and may select a correction method by comparing measured signal quality with the reference signal quality.

For example, the processor 310 may identify the reference signal quality (e.g., RSSI 100 dbm). When measured signal quality is higher than the reference signal quality, the processor 310 may perform image stabilization by combining the first correction and the second correction. In contrast, when the reference signal quality is higher than measured signal quality, the processor 310 may select only the second correction and perform image stabilization. A method of performing, by the processor 310, image stabilization based on signal quality of the antenna 360 is not limited to the aforementioned embodiments.

TABLE 1

| Sub- | LTE B5 (850 MHz) | | | LTE 12 (700 MHz) | | |
|---|---|---|---|---|---|---|
| ject | Camera | First | Second | Camera | First | Second |
| A | off | correction | correction | off | correction | correction |
| TIS | −95.2 | −93.1 | −94.2 | −92.4 | −88.3 | −90.1 |
| | dBm | dBm | dBm | dBm | dBm | dBm |

Table 1 illustrates total isotropic sensitivities (TISs) of the antenna 360, which was measured when the first correction and the second correction were performed while the camera 350 did not operate. With reference to Table 1, when the camera 350 operates, radiation performance of the antenna 360 may be reduced. In LTE B5, the TIS has antenna performance of −95.2 dBm when the camera 350 does not operate, but may have antenna performance having a lower numerical value than −95.2 dBm when image stabilization is performed. Likewise, even in LTE 12, when the camera 350 operates, radiation performance of the antenna may be reduced. When the processor 310 performs image stabilization, an interference signal delivered to the antenna in the second correction may be smaller than an interference signal delivered to the antenna in the first correction. From Table 1, it may be seen that the TIS when the second correction is performed is smaller than that when the camera 350 does not operate, but is higher than that when the first correction is performed. According to an embodiment, when the processor 310 performs image stabilization by using both the first correction and the second correction, some of necessary correction values may be used for the first correction, and the remainder thereof may be used for the second correction.

According to various embodiments, the processor 310 may select a correction method based on ambient illuminance of the electronic device 300. When ambient illuminance of the electronic device 300 is low, it may be difficult for the processor 310 to perform image stabilization because a shutter speed of the camera 350 is reduced. In order to solve such a problem, the processor 310 may obtain ambient illuminance of the electronic device from the illuminance sensor 330 and perform image stabilization based on the ambient illuminance. The processor 310 may identify reference illuminance of the electronic device 300, and may select a correction method by comparing ambient illuminance of the electronic device 300 with the reference illuminance.

For example, the processor 310 may select only the second correction in first illuminance higher than reference illuminance (e.g., 1000 lux per 1/120 second), and may perform image stabilization. In contrast, in second illuminance higher than the reference illuminance, the processor 310 may perform image stabilization by combining the first correction and the second correction. A method of performing, by the processor 310, image stabilization based on ambient illuminance is not limited to the aforementioned embodiment.

According to various embodiments, the processor 310 may select a correction method based on a degree of the shaking of a hand. As a hand of a user that comes into contact with the electronic device 300 is shaken, the electronic device 300 may also be shaken. The processor 310 may obtain a vibration angle of the electronic device 300 from the vibration sensor 340, and may perform image stabilization based on the vibration angle. The processor 310 may identify a reference angle of the electronic device 300, and may select a correction method by comparing a vibration angle of the electronic device 300 with the reference angle.

For example, the processor 310 may identify a reference angle (e.g., 0.7 degree in the photo photographing mode and 1.5 degree in the video photographing mode) of the electronic device 300. When a vibration angle of the electronic device 300 is smaller than the reference angle, the processor 310 may select the first correction and perform image stabilization. In contrast, when the vibration angle is greater than the reference angle, the processor 310 may select the second correction and perform image stabilization. A method of performing, by the processor 310, image stabilization based on a vibration angle is not limited to the aforementioned embodiments.

According to various embodiments, the processor 310 may identify a correction method selection criterion based on a photographing mode of camera application. When executing the camera application, the processor 310 may display, on the display 320, a graphic user interface (UI) in which a photographing mode may be changed based on a touch input of a user. For example, the processor 310 may display the graphic UI on the lower side of the camera application, and may identify the photo photographing mode, the video photographing mode, and the video call mode based on a user input. The processor 310 may identify a different correction method selection criterion based on each photographing mode.

For example, the processor 310 may perform image stabilization on the basis of illuminance and a degree of the shaking of a hand in the photo photographing mode, may perform image stabilization on the basis of illuminance and signal quality of the antenna in the video photographing mode, and may perform image stabilization on the basis of signal quality of the antenna in the video call mode. The processor 310 may change a photographing mode based on a user input, and may identify a correction method selection criterion based on the change. An embodiment of the disclosure is not limited to the aforementioned correction methods, and a correction method may be identified by combining various correction method selection criteria.

According to various embodiments, the processor 310 may identify priorities of various correction criteria. The processor 310 may identify a correction method based on at least one correction criterion depending on the situation. When using two or more criteria, the processor 310 may identify a criterion that is preferentially applied among the two or more criteria. For example, the processor 310 may identify that priorities are higher in order of ambient illuminance, a degree of the shaking of a hand, and signal quality of the antenna. That is, if the first correction has to be performed on the basis of a degree of the shaking of a hand, but both the first correction and the second correction need to be performed on the basis of ambient illuminance, the processor 310 may identify to perform both the first correction and the second correction.

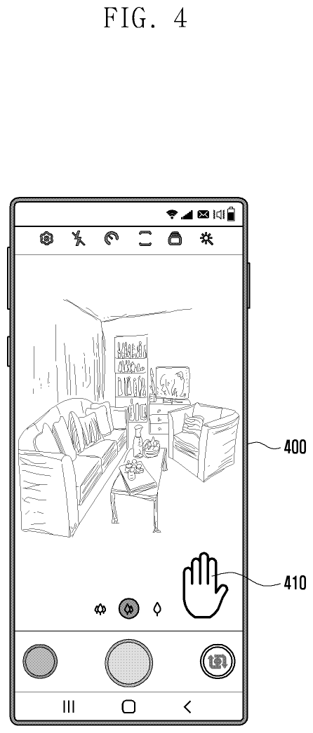

FIG. 4 illustrates an embodiment in which a graphic UI is displayed in a camera application of an electronic device according to an embodiment of the disclosure.

Referring to FIG. 4, a processor (e.g., the processor 310 in FIG. 3) may recognize an object ahead of or behind the electronic device 400 by executing the camera application. The processor may display a preview of the recognized object on a display (e.g., the display 320 in FIG. 3). According to various embodiments, the processor may further display, in one area of the display, a graphic UI 410 indicative of image stabilization. The processor may select a method of performing image stabilization on a camera (e.g., the camera 350 in FIG. 3) based on a user input to the graphic UI 410.

For example, the processor may receive a touch input to the graphic UI 410, and may switch the first correction and the second correction. The processor may perform the first correction by controlling the camera in an initial situation in which a touch input of a user is not received. The processor may be configured to stop the first correction and to perform the second correction, when receiving a first touch input of a user for the graphic UI 410. When receiving a second touch input of a user for the graphic UI 410, the processor may stop the second correction, and may perform the first correction by controlling the camera.

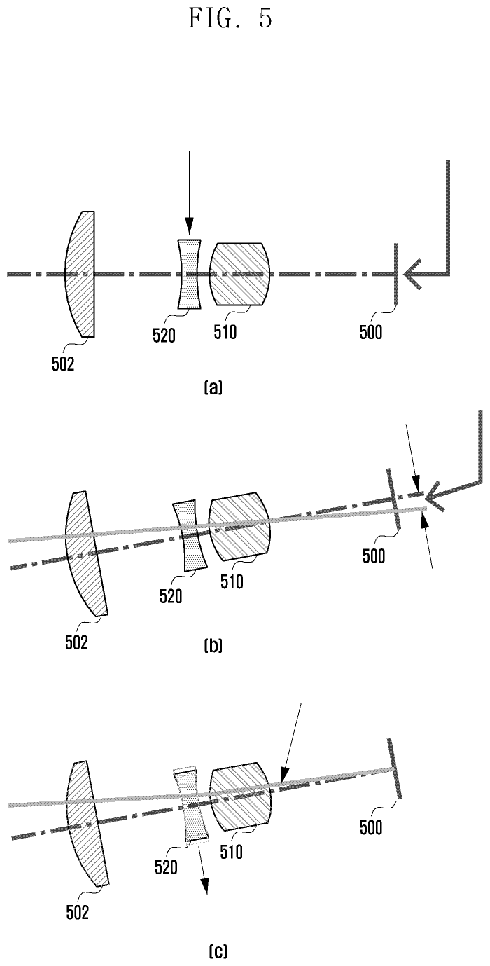

FIG. 5 illustrates an operating principle of the first correction of an electronic device according to an embodiment of the disclosure.

Referring to FIG. 5, a camera (e.g., the camera 350 in FIG. 3) may include a main lens 510 and a correction lens 520, and may sense, through an optical sensor 500, light received through the main lens 510 and the correction lens 520 from an object 502. Hereinafter, the first correction among methods of performing image stabilization is described in detail.

Referring to part (a) of FIG. 5, all of the main lens 510, the correction lens 520, and the optical sensor 500 are disposed on a straight line, and may recognize an image of the object 502. When a user aligns the object 502 with an optical axis of the optical sensor 500 by moving the electronic device, the optical sensor 500 may sense light received by being reflected by the object 502. A processor (e.g., the processor 310 in FIG. 3) may generate an image (e.g., a preview) by processing an image of the object 502 sensed by the optical sensor 500, and may display the generated image on a display (e.g., the display 320 in FIG. 3).

Part (b) of FIG. 5 is a diagram illustrating the state in which the shaking of a hand attributable to a user has occurred. Locations of the main lens 510 and the correction lens 520 in the state in which the first correction does not operate may maintain a straight line with the optical sensor 500. Accordingly, a clear image may not be formed because the optical axis deviates from the center of the object 502. That is, if a speed at which an image of the object 502 is shaken is faster than a shutter speed of the camera, a degree of definition of the image may deteriorate.

Part (c) of FIG. 5 illustrates that the processor performs the first correction by controlling the camera. For image stabilization, the processor may move the location of the correction lens 520 and perform the first correction (i.e., a lens shift). The processor may detect the shaking of the electronic device by using various sensors (e.g., a vibration sensor (e.g., the vibration sensor 340 in FIG. 3), a gyro sensor, an acceleration sensor) included in a sensor module (e.g., the sensor module 176 in FIG. 1). The processor may move the correction lens 520 in a direction opposite to a direction in which the electronic device is shaken, based on the detected shaking of the electronic device. For example, the processor may correct the shaking of the electronic device by moving the correction lens 520 to the right when the electronic device moves to the left and moving the correction lens 520 to the left when the electronic device moves to the right.

An electronic device according to various embodiments may include a camera, an antenna, and a processor operatively connected to the camera and the antenna. The processor may obtain an image of an object by controlling the camera, may obtain signal quality received by the antenna, and may select and perform, based on the signal quality, at least one of a first correction for moving a lens of the camera based on a vibration direction of the electronic device and a second correction for generating a corrected image based on at least some area of the image of the object.

According to various embodiments, the processor may further identify a photographing mode of the camera based on a user input, and identify a criterion for selecting at least one of the first correction and the second correction based on the photographing mode.

According to various embodiments, the electronic device may further include an illuminance sensor and a vibration sensor. The processor may obtain ambient illuminance of the illuminance sensor, and may obtain a vibration angle from the vibration sensor.

According to various embodiments, the processor may select at least one of the first correction and the second correction based on the ambient illuminance and the vibration angle, based on the photographing mode being a photo photographing mode.

According to various embodiments, the photo photographing mode may include an operation of recognizing the object in a preview screen.

According to various embodiments, the processor may select at least one of the first correction and the second correction based on the ambient illuminance and the signal quality of the antenna, based on the photographing mode being a video photographing mode.

According to various embodiments, the processor may select at least one of the first correction and the second correction based on the signal quality of the antenna, based on the photographing mode being a video call mode.

According to various embodiments, the electronic device may further include a display. The processor may display, on a display, a graphic user interface (UI) indicative of image stabilization based on a camera application being executed, and may select at least one of the first correction and the second correction based on a user input to the graphic UI.

According to various embodiments, the processor may identify the signal quality of the antenna by using parameters, such as a received signal strength indicator (RSSI), reference signal received power (RSRP), and received signal code power (RSCP).

According to various embodiments, the first correction may include methods, such as an optical image stabilizer (OIS) and a tilt optical image stabilizer (tOIS).

According to various embodiments, the second correction may include methods, such as a video digital image stabilizer (VDIS), an electric image stabilizer (EIS), and a digital image stabilizer (DIS).

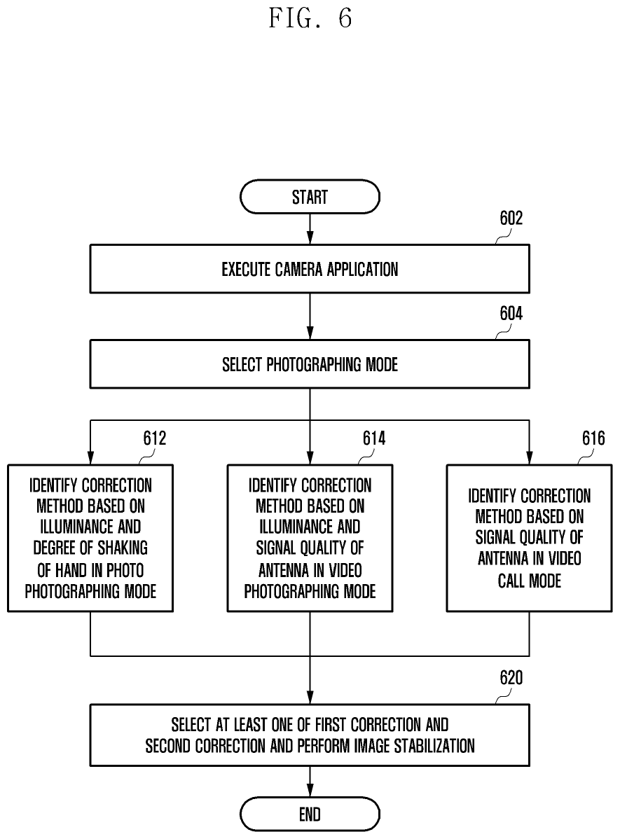

FIG. 6 is a flowchart of a method of performing, by an electronic device, image stabilization according to an embodiment of the disclosure.

The method described with reference to FIG. 6 may be performed by an electronic device (e.g., the electronic device 101 in FIG. 1) described with reference to FIGS. 1 to 5. Hereinafter, a description of the aforementioned technical characteristics is omitted.

Referring to FIG. 6, according to various embodiments, in operation 602, the electronic device may execute the camera application. The electronic device may display, on a display (e.g., the display 320 in FIG. 3), a graphic UI indicative of the switching of the camera, and may switch a front camera and a rear camera based on a user input to the graphic UI.

According to various embodiments, in operation 604, the electronic device may select a photographing mode. The electronic device may provide at least one photographing mode which provides various functions in the camera application. For example, the electronic device may select at least one photographing mode among the photo photographing mode, the video photographing mode, and the video call mode. According to an embodiment, in the case of the video call mode, the electronic device may activate the front camera by controlling a camera (e.g., the camera 350 in FIG. 3).

According to various embodiments, the electronic device may select a proper method among various methods of performing image stabilization based on at least one criterion. According to various embodiments, the electronic device may select a correction method based on signal quality of the antenna. An operation of the camera may affect signal quality of an antenna (e.g., the antenna 360 in FIG. 3) because the camera and the antenna may be disposed close to each other. The electronic device may measure signal quality of the antenna and perform image stabilization based on the measured signal quality. The electronic device may identify reference signal quality, and may select a correction method by comparing the measured signal quality with the reference signal quality.

According to various embodiments, the electronic device may select a correction method based on ambient illuminance of the electronic device. When ambient illuminance of the electronic device is low, it may be difficult for the electronic device to perform image stabilization because a shutter speed of the camera is small. In order to solve such a problem, the electronic device may obtain ambient illuminance from an illuminance sensor (e.g., the illuminance sensor 330 in FIG. 3), and may perform image stabilization based on the ambient illuminance. The electronic device may identify reference illuminance, and may select a correction method by comparing the ambient illuminance with the reference illuminance.

According to various embodiments, the electronic device may select a correction method based on a degree of the shaking of a hand. As a hand of a user who comes into contact with the electronic device is shaken, the electronic device may also be shaken. The electronic device may obtain a vibration angle of the electronic device from a vibration sensor (e.g., the vibration sensor 340 in FIG. 3), and may perform image stabilization based on the vibration angle. The electronic device may identify a reference angle, and may select a correction method by comparing a vibration angle of the electronic device with the reference angle.

According to various embodiments, the electronic device may identify a correction method selection criterion based on a photographing mode of the camera application. When executing the camera application, the electronic device may display, on the display, a graphic UI in which a photographing mode may be changed based on a touch input of a user. For example, the electronic device may display the graphic UI on the lower side of the camera application, and may identify the photo photographing mode, the video photographing mode, and the video call mode based on a user input. The electronic device may identify a different correction method selection criterion based on each photographing mode.

According to various embodiments, in operation 612, the electronic device may identify a correction method on the basis of illuminance and a degree of the shaking of a hand in the photo photographing mode. The electronic device may obtain ambient illuminance of the electronic device from the illuminance sensor, and may obtain a vibration angle of the electronic device from the vibration sensor. The electronic device may identify how to perform image stabilization based on the obtained information.

According to various embodiments, in operation 614, the electronic device may identify a correction method on the basis of illuminance and signal quality of the antenna in the video photographing mode. The electronic device may identify a method of performing image stabilization by obtaining ambient illuminance of the electronic device from the illuminance sensor and measuring signal quality of the antenna.

According to various embodiments, in operation 616, the electronic device may identify a correction method on the basis of signal quality of the antenna in the video call mode. The electronic device may identify a correction method by measuring signal quality of the antenna.

According to various embodiments, in operation 620, the electronic device may select at least one of the first correction and the second correction, and may perform image stabilization. The electronic device may perform image stabilization by using various methods. For example, the electronic device may perform image stabilization by using a first correction (e.g., optical image stabilization (OIS) or tilt optical image stabilization (tOIS)) for performing image stabilization by using a physical movement of a lens of the camera and a second correction (e.g., video digital image stabilization (VDIS), an electric image stabilizer (EIS), or a digital image stabilizer (DIS)) for generating a corrected image by cropping at least one area of an image of an object.

According to various embodiments, the electronic device may identify priorities of various correction criteria. The electronic device may identify a correction method based on at least one correction criterion depending on the situation. When using two or more criteria, the electronic device may identify a criterion that is preferentially applied among the two or more criteria. For example, the electronic device may identify that priorities are higher in order of ambient illuminance, a degree of the shaking of a hand, and signal quality of the antenna. That is, if the first correction has to be performed on the basis of a degree of the shaking of a hand, but both the first correction and the second correction need to be performed on the basis of ambient illuminance, the electronic device may identify to perform both the first correction and the second correction.

According to various embodiments, a method of performing, by an electronic device, image stabilization in which antenna performance is taken into consideration may include operations of obtaining an image of an object by controlling a camera, obtaining signal quality received by the antenna, and selecting and performing, based on the signal quality, at least one of a first correction for moving a lens of the camera based on a vibration direction of the electronic device and a second correction for generating a corrected image based on at least some area of the image of the object.

According to various embodiments, the operation of selecting and performing at least one correction may further include operations of further identifying a photographing mode of the camera based on a user input and identifying a criterion for selecting at least one of the first correction and the second correction based on the photographing mode.

According to various embodiments, the method may further include operations of obtaining ambient illuminance from an illuminance sensor and obtaining a vibration angle from a vibration sensor.

According to various embodiments, the operation of selecting and performing at least one correction may further include an operation of selecting at least one of the first correction and the second correction based on the ambient illuminance and the vibration angle, based on the photographing mode being a photo photographing mode.

According to various embodiments, the photo photographing mode may include an operation of recognizing the object in a preview screen.

According to various embodiments, the operation of selecting and performing at least one correction may further include an operation of selecting at least one of the first correction and the second correction based on the ambient illuminance and the signal quality of the antenna, based on the photographing mode being a video photographing mode.

According to various embodiments, the operation of selecting and performing at least one correction may further include an operation of selecting at least one of the first correction and the second correction based on the signal quality of the antenna, based on the photographing mode being a video call mode.

According to various embodiments, the operation of selecting and performing at least one correction may further include operations of displaying, on a display, a graphic user interface (UI) indicative of image stabilization based on a camera application being executed and selecting at least one of the first correction and the second correction based on a user input to the graphic UI.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a camera;
an antenna; and
at least one processor operatively connected to the camera and the antenna,
wherein the at least one processor is configured to:
obtain an image of an object by controlling the camera,
obtain signal quality received by the antenna, and
select and perform, based on the signal quality, at least one of a first correction for moving a lens of the camera based on a vibration direction of the electronic device and a second correction for generating a corrected image based on at least some area of the image of the object.

2. The electronic device of claim 1, wherein the at least one processor is further configured to:
identify a photographing mode of the camera based on a user input; and
identify a criterion for selecting at least one of the first correction and the second correction based on the photographing mode.

3. The electronic device of claim 2, further comprising an illuminance sensor and a vibration sensor:
wherein the at least one processor is configured to:
obtain ambient illuminance of the illuminance sensor, and
obtain a vibration angle from the vibration sensor.

4. The electronic device of claim 3, wherein the at least one processor is further configured to select at least one of the first correction and the second correction based on the ambient illuminance and the vibration angle, based on the photographing mode being a photo photographing mode.

5. The electronic device of claim 4, wherein the photo photographing mode comprises an operation of recognizing the object in a preview screen.

6. The electronic device of claim 3, wherein the at least one processor is further configured to select at least one of the first correction and the second correction based on the ambient illuminance and the signal quality of the antenna, based on the photographing mode being a video photographing mode.

7. The electronic device of claim 3, wherein the at least one processor is further configured to select at least one of the first correction and the second correction based on the signal quality of the antenna, based on the photographing mode being a video call mode.

8. The electronic device of claim 3, further comprising a display,
wherein the at least one processor is further configured to:
display, on the display, a graphic user interface (UI) indicative of image stabilization based on a camera application being executed, and
select at least one of the first correction and the second correction based on a user input to the graphic UI.

9. The electronic device of claim 1, wherein the at least one processor is further configured to identify the signal quality of the antenna by using parameters comprising a received signal strength indicator (RSSI), reference signal received power (RSRP), and received signal code power (RSCP).

10. The electronic device of claim 1, wherein the first correction comprises methods comprising an optical image stabilizer (OIS) and a tilt optical image stabilizer (tOIS).

11. The electronic device of claim 1, wherein the second correction comprises methods comprising a video digital image stabilizer (VDIS), an electric image stabilizer (EIS), and a digital image stabilizer (DIS).

12. A method of performing, by an electronic device, image stabilization in which antenna performance is taken into consideration, the method comprising:
obtaining an image of an object by controlling a camera;
obtaining signal quality received by an antenna; and
selecting and performing, based on the signal quality, at least one of a first correction for moving a lens of the camera based on a vibration direction of the electronic device and a second correction for generating a corrected image based on at least some area of the image of the object.

13. The method of claim 12, wherein the selecting and performing at least one of the first correction and the second correction further comprises:
identifying a photographing mode of the camera based on a user input; and
identifying a criterion for selecting at least one of the first correction and the second correction based on the photographing mode.

14. The method of claim 13, further comprising:
obtaining ambient illuminance from an illuminance sensor; and
obtaining a vibration angle from a vibration sensor.

15. The method of claim 14, wherein the selecting and performing at least one of the first correction and the second correction further comprises selecting at least one of the first correction and the second correction based on the ambient illuminance and the vibration angle, based on the photographing mode being a photo photographing mode.

16. The method of claim 15, wherein the photo photographing mode comprises an operation of recognizing the object in a preview screen.

17. The method of claim 14, wherein the selecting and performing at least one of the first correction and the second correction further comprises selecting at least one of the first correction and the second correction based on the ambient illuminance and the signal quality of the antenna, based on the photographing mode being a video photographing mode.

18. The method of claim 14, wherein the selecting and performing at least one of the first correction and the second correction further comprises selecting at least one of the first correction and the second correction based on the signal quality of the antenna, based on the photographing mode being a video call mode.

19. The method of claim 14, wherein the selecting and performing at least one of the first correction and the second correction further comprises:
displaying, on a display, a graphic user interface (UI) indicative of image stabilization based on a camera application being executed; and
selecting at least one of the first correction and the second correction based on a user input to the graphic UI.

20. The method of claim 19, wherein the photographing mode is one of a photo photographing mode, video photographing mode, or a video call mode.

21. The method of claim 20, wherein each photographing mode has a different correction method selection criterion.

22. The method of claim 21,
wherein, when receiving a first touch input of a user for the graphic UI while performing the first correction, stop performing the first correction and perform the second correction, and
wherein, when receiving a second touch input of the user for the graphic UI while performing the second correction, stop performing the second correction and perform the first correction by controlling the camera.

23. The method of claim 12, wherein the selecting and performing the at least one of the first correction and the second correction comprises:
selecting the first correction and the second correction in case that a measured signal quality is higher than a reference signal quality; and
selecting only the second correction from among the first correction and the second correction, in case that the reference signal quality is higher than the measured signal quality.
